(19) United States
(12) Patent Application Publication
(10) Pub. No.: US 2003/0140999 A1
(43) Pub. Date: Jul. 31, 2003

(54) Motor vehicle tires

(76) Inventors: Krag C. Smith, Olney, MD (US); William L. Klima, Fredericksburg, VA (US); Walter F. Klima JR., Travelers Rest, SC (US)

Correspondence Address: WILLIAM L. KLIMA, 2046-C JEFFERSON DAVIS HIGHWAY, STAFFORD, VA, 22554, US

(21) Appl. No.: 10/055,966

(22) Filed: Jan. 28, 2002

(51) Int. Cl. B60C 1/00; B60C 5/00; B60C 11/00; B60C 13/00; B60C 13/04; B60C 19/00

(52) U.S. Cl. 152/524; 152/209.5; 152/525; 152/450; 152/151; 152/152.1

(57) ABSTRACT

The present invention is directed to a motor vehicle tire, preferably a colored motor vehicle tire. The tire is configured so that a significant portion of the external surface of the tire displays colors. Preferably, the chemical composition of the tire is colored so that when the tire is formed the tire is colored throughout its depth and colorfast, and in the case of the tread portion does not change color significantly with wear. In a preferred embodiment, the chemical composition of the tire is provided with a coloring agent or additive such as a pigment or dye that will yield a desired color upon completion of the tire manufacturing process. Such dye or pigment may be enhanced by the use of reflective, luminescent or photochromic agents that will enhance certain effects and appearances of the tire including ease of visibility, other safety concerns including wear, puncture identification, and enhanced aesthetic appearance. The tire can be color coordinated with the vehicle's exterior paint, wheels, and interior colors and trim.

### FIELD OF THE INVENTION

This invention relates to motor vehicle tires, in particular colored motor vehicle tires. This invention also relates to an article of manufacture and the process for manufacturing such colored vehicle tires.

### BACKGROUND OF THE INVENTION

Today, all modern day motor vehicle tires on automobiles, trucks, sport utility vehicles (SUVs), vans, buses, tractor trailers, heavy equipment, recreational vehicles (RVs), motorcycles, mopeds, are black. Some of these black tires are aesthetically enhanced by providing white walls, raised white letters, and white or colored pin stripes. Currently, there is no known tires that are significantly colored (i.e. greater than twenty-five percent of the exposed exterior surface of the tire displays a colored surface). Further, there is no known colored tires significantly color coordinated with the rest of the motor vehicle (e.g. exterior paint and exterior trim, wheel colors and/or finishes, and interior colors and interior trim). Even further, there is no known motor vehicle tires manufactured with a colored chemical composition, for example made, with a color throughout the chemical composition, including or excluding other interior components of the tire (e.g. reinforcing belts, mesh and/or wire).

It is believed that the use of colored motor vehicle tires will have many advantages over today's black tires. For instance, such tires may be configured to show or indicate the extent of wear, or even signal a dangerous condition of a tire such as excessive wear, excessive temperature, excessive or too little air pressure, and even indicate damage to a tire. The tires can be configured to visually indicate wear by change of color, and/or a tire can be configured to cooperate with a sensor, for example positioned in a wheel well, to automatically monitor the wear and/or safety conditions of a tire. For example, the sensor can be configured to detect color change and/or temperature to trigger an audio and/or visual alarm to an operator of the motor vehicle (e.g. dash board warning system).

As a further example, dirt and/or oil from the road picked up by a damaged tire will contrast starkly with the color of the non-black tire. By tracking such damage, a mechanic maybe better able to determine what maintenance steps are needed for that tire. In addition, the need for and the proper direction of tire rotations can be better determined by the mechanic or other maintenance person who can see signs of tire wear by inspecting the wear patterns on the colored tire.

Moreover, tire wear that shows up clearly can be used to spot punctures that have occurred and may be used to spot potential trouble areas such as a tire bulge or cracking that might soon prove to be dangerous or, for example, a weak spot that is developing in the tire. The use of a non-black color, for example red, that is dispersed entirely throughout the tire composition will thus produce fresh red scuffs or streaks or similar signs of damage and wear. This is in contrast to the oily black color that may develop over the worn flat portions of the tread that are constantly in contact with the oily surface of the roads. Such fresh marks of a non-black color would underscore newly developed cracks or other disturbance of the tires and would be more easily seen as they are of a lighter-than-black color.

Aside from tire maintenance, other types of vehicle maintenance may also be indicated by studying the wear patterns on non-black tires. For instance, a tire having too much wear on the inside of the tire may mean that the tires and wheels need to be balanced or that the wheels are out of alignment.

It is also believed that using tires that are of a solid non-black color will provide a greater degree of safety for both pedestrians and passengers/drivers of motor vehicles. Such tires will highlight the appearance of a vehicle at night as well as provide a better visual picture of the vehicle during the day. Such colored tires may include coloring agents and other compositions that provide reflectance and will produce a greater reflectance than the standard black tires that are currently in use on vehicles. Such compositions may include reflective material in the dye or pigment and/or the use of reflective materials in the tire in addition to the dye or pigment.

Such colored tires could be operating in connection with the small amount of light that is present from street lights and the other sources of light during the night so that a lighter than black color of the tire surface will provide a visual warning at night that can be seen by motorists, pedestrians and/or animals. Such visual appearance may be enhanced by the use of reflective materials in the pigments and/or other coloring agents used in the tire composition.

In addition, the aesthetic beauty of a colored motor vehicle tire may enhance the visual appearance of the motor vehicle upon which it is used. It is thought possible that such colored motor vehicle tires will provide such a striking appearance for the motor vehicle that such tires maybe used at trade shows or other automotive displays where the color of the tires will draw attention first to the tires and then to the vehicle itself.

It is believed that there are benefits to making the exterior surface of tires and/or the chemical composition of the tire colored other than black and such benefits and advantages that would accrue will be recognized by those skilled in the art, once the invention is shown and described.

### SUMMARY OF THE INVENTION

The invention is directed to a color motor vehicle tire. A preferred embodiment is a single non-black and non-white colored motor vehicle tire that is more distinct and visually striking than the state of the art black color that is in use nowadays. Such tire compositions that are in use may be enhanced by coloring agents or additives such as dyes and pigments that will be dispersed throughout the chemical compositions (e.g. rubber composition) of the tire, and will serve to color the tire a distinctive, non-black and non-white, color that remains throughout the tire. Such pigments and/or coloring agents or additives may include reflective materials to enhance the visual appearance of such a tire at night. Colors such as reds, blues, greens, yellows, browns as well as lighter shades and more earthy tones may be produced by the different types and combinations of the dyes and pigments.

The visual effect of such chemical compositions may be enhanced by the use of components that provide luminescent, reflective and/or photochromic properties to the tire material in question. Such pigments, and dyes may be chosen from state of the art materials. The invention also includes a method or process for manufacturing such tires as well as the colored tires according to the present invention.

A first object of the present invention is to provide an improved motor vehicle tire.

A second object of the present invention is to provide a colored motor vehicle tire.

A third object of the present invention is to provide a motor vehicle tire having a significant portion of the external surface of the tire being colored.

A fourth object of the present invention is to provide a motor vehicle tire having a significant viewable portion of the external surface of the tire being colored.

A fifth object of the present invention is to provide a motor vehicle tire made of a chemical composition having a non-black and non-white color that is substantially uniformly or solidly and evenly dispersed throughout the chemical composition so that the tire will have a non-black and non-white appearance.

A six object of the present invention is to provide a motor vehicle tire made of a chemical composition having a non-black and non-white color that is substantially uniformly or solidly and evenly dispersed throughout the chemical composition so that the tire will have a non-black and non-white appearance even as the tire wears.

A seventh object of the present invention is to provide a motor vehicle tire that is of a color other than black and white, and having a striking visual appearance that will alert motorists and pedestrians that a moving motor vehicle is in the area.

An eighth object of the present invention is to provide a motor vehicle tire having a dye or pigment in the chemical composition that indicates signs of wear on the tire and provides a greater visual indication of signs of wear and/or damage to the tire.

A ninth object of the present invention is to provide a motor vehicle tire that is of a color other than black and white, and will have a visual appearance that is readily apparent at night so as to provide a greater visual warning to motorists and pedestrians that a vehicle is approaching.

A tenth object of the present invention is to provide a motor vehicle tire having a non-black and non-white color and appearance that will enhance the aesthetic appeal of a motor vehicle by drawing attention to the tires of the motor vehicle that would otherwise be of an ordinary state of the art black color.

The present invention is directed to motor vehicle tires, in particular colored motor vehicle tires. The word “colored” means, all primary colors and all shades therebetween, and specifically excluding all black, substantially all black, all white and substantially all white motor vehicle tires.

The motor vehicle tires according to the present invention are significantly colored. Specifically, the colored motor vehicle tires according to the present invention are colored on at least twenty-five percent (25%) of the exterior surface of the tire. The exterior surface is the combination of both outer sidewall surfaces and outer tread surface, or otherwise the outer surface viewable or potentially viewable to an observer viewing a motor vehicle tire not yet mounted on a motor vehicle and viewable on all sides. The colored motor vehicle tire according to the present invention is preferably colored on at least thirty percent (30%) ofthe exterior surface of the tire, more preferably on at least thirty-five percent (35%) of the exterior surface of the tire, even more preferably colored on at least fifty percent (50%) of the exterior surface of the tire, and even further more preferably colored on at least ninety percent (90%) of the exterior surface of the tire. Most preferably, one-hundred percent (100%) or the entire exterior surface of the tire is colored.

Alternatively, only the exterior surface of the outer sidewall surface is significantly colored (excluding the colors black and white). Specifically, at least five percent (5%) ofthe outer sidewall is colored, preferably, at least ten percent (10%), more preferably at least twenty percent (20%), even more preferably at least fifty percent (50%), and most preferably one-hundred percent (100%) of the exterior surface of the outer sidewall surface is colored, excluding black and white. As a further alternative both the outer sidewall surface and outer side thread portion is significantly colored.

As a further alternative, at least thirty-five percent (35%) of the combined outer surface of the outer sidewall surface and outer tread surface are colored, excluding black and white. Preferably, at least forty percent (40%), more preferably fifty percent (50%), even more preferable eighty percent (80%), and even further preferred ninety percent (90%), andmost preferably one-hundred percent (100%) ofthe combined exterior surface of the outer sidewall surface and outer tread surface are colored, excluding white. In any event, the motor vehicle tires according to the present invention are significantly colored versus the current all black or substantially all black tires of motor vehicles today.

The motor vehicle tires according to the present invention are configured to visually display color to an observer viewing the tire mounted on a motor vehicle. Thus, at least a portion of the external surface of the tire must be colored. For example, an outer layer of chemical composition forming the exterior surface of the tire according to the present invention can be colored, or the outer layer of the surface is treated to be colored. Preferably, the entire chemical composition used to form the tire is colored throughout so that the color is stable over time, scrub-proof, wear-proof, durable and/or colorfast. Maintaining the color fastness of a tire can be important when the tire is color coordinated with other parts or portions of the vehicle, including the exterior paint and trim, wheel finish and/or interior colors and trim of the vehicle. Further, the chemical composition should be carefully designed and selected so that the exterior surface of the tire remains fadeproof against electromagnetic radiation (e.g. ultraviolet rays from sunlight). Even further, the chemical composition should be selected so as to be highly stable and not subject to deterioration due to weather and/or aging factors.

The coloring of a motor vehicle tire according to the present invention has almost unlimited possibilities. Specifically, the exterior surface of the tire can be a single color, shaded, patterned (e.g. stripes, geometrical shapes, camouflage, symbols, logos, indicia, words, messages, artwork, etc.). As an example, the exterior surface of the tires according to the present invention can match and/or accent the exterior paint and/or trim colors of the vehicle and the geometry of the motor vehicle, components and/or trim. Further, the chemical composition forming the tires can include additives and/or agents for providing surface reflectants, luminance, phosphorescence and other special properties or appearances. Further, additives and/or agents can be added to the chemical composition so that tire changes color with temperature and/or pressure of the tire. For example, liquid crystal (e.g. leuco dyes) can be added with a particular chemical composition (e.g. white or light colored base color or matrix) to accept such agents or additives. The tire can be configured so that the color of the tire can change with speed due to a change of pressure exerted on the tire and/or the temperature change of the tire selected to transition colors at different speeds. Still further, under layers of the tire can be colored while having an outer clear and/or colorless layer protecting same. In this particular arrangement, the tire can be provided with a power source and lights (e.g. string lights) within one or more layers of the tire to provide specialized visual effects.

The colored motor vehicle tire according to the present invention can have various surface textures on the exterior surface thereof. For example, the surface can be substantially smooth, roughened, textured, patterned, raised or otherwise sculptured. The combination of coloring and texturing of the exterior surface of the tire can provide special visual effects.

### BRIEF DESCRIPTION OF THE DRAWINGS

FIG. 1 is a perspective view of a motor vehicle tire according to the present invention.

FIG. 2 is a side elevational view of a motor vehicle tire according to the present invention.

FIG. 3 is a elevational end view of the motor vehicle tire according to the present invention shown in FIGS. 1 and 2.

FIG. 4 is a cross-sectional view of the motor vehicle tire according to the present invention, as indicated in FIG. 2.

FIG. 5 is a cross-sectional of another embodiment of a motor vehicle tire according to the present invention.

FIG. 6 is a side elevational view of a further embodiment of a motor vehicle tire according to the present invention.

FIG. 7 is a side elevational view of an even further embodiment of a motor vehicle tire according to the present invention.

FIG. 8 is an end elevational view of even another embodiment of the motor vehicle tire according to the present invention.

FIG. 9 is a cross-sectional view of another embodiment of a motor vehicle tire according to the present invention.

FIG. 10 is an illustrative side elevational view of an embodiment of a motor vehicle tire according to the present invention.

FIG. 11 is an illustrative side elevational view of another embodiment of a motor vehicle tire according to the present invention.

FIG. 12 is an illustrative side elevational view of a further embodiment of a motor vehicle tire according to the present invention.

FIG. 13 is an illustrative side elevational view of an even further embodiment of a motor vehicle tire according to the present invention.

FIG. 14 is an illustrative side elevational view of an even further embodiment of a motor vehicle tire according to the present invention.

### DETAILED DESCRIPTION OF PREFERRED EMBODIMENTS

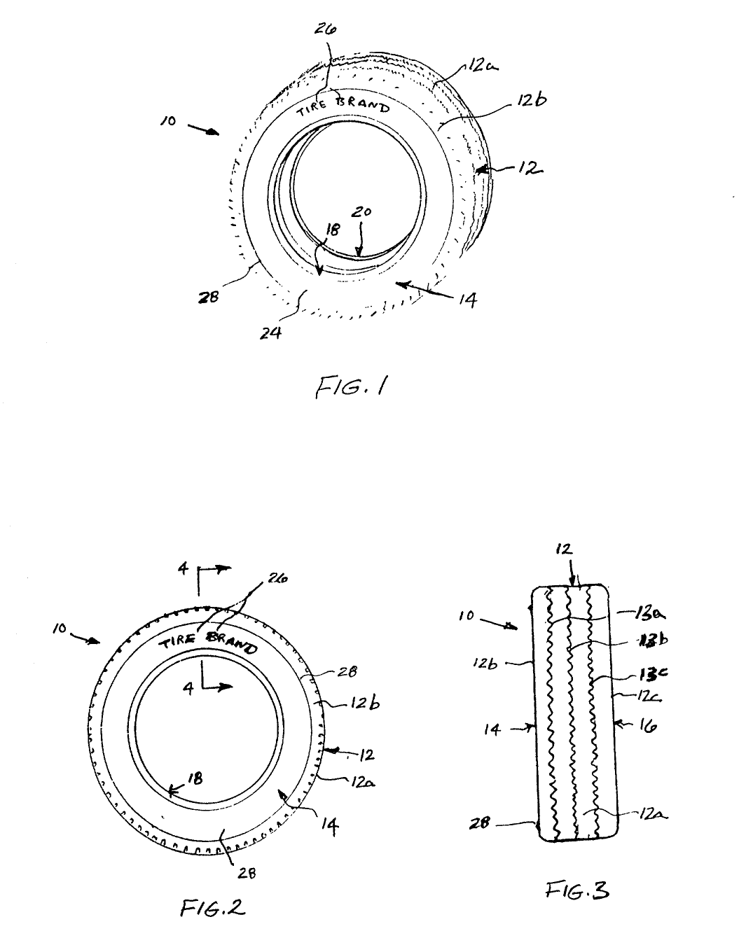

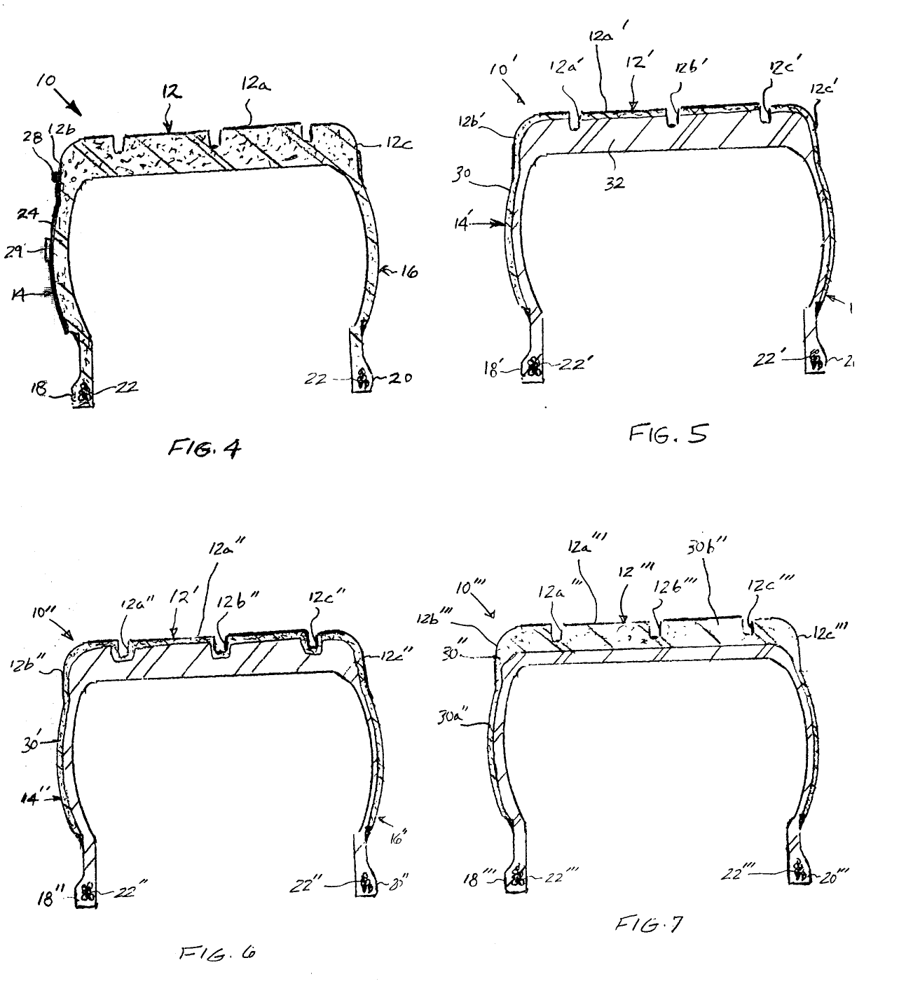

A motor vehicle tire 10 according to the present invention is shown in FIG. 1 and FIG. 4.

The tire 10 is defined by an outer tread portion 12, an outer sidewall portion 14, inner sidewall portion 16, outer bead portion 18, and inner bead portion 20. The sidewalls 14 and 16 connect the tread portion 12 to the bead portions 18 and 20. The tread portion 12 is further defined by tread width portion 12a (i.e. portion more or less making contact with road), outer side tread portion 12b located adjacent outer sidewall portion 14, and inner side tread portion 12c located adjacent inner sidewall portion 16.

The tire 10 may include one or more internal belt portions for reinforcing the tire material, and wires 22 for reinforcing the bead portions 18 and 20. The tread portion 12 is shown having three (3) separate zig-zag type treads 13a, 13b and 13c. However, the number of treads, the design and pattern of the treads, the width of the treads, the depth of the treads and other parameters involving or relating to the treads can be modified for performance, appearance, weather conditions, wear, visual appearances, and other factors. In addition, the outer sidewall 14 (or possibly even the inner sidewall 16) can be provided with whitewalls, colored walls and/or raised lettering having the same or different color or colors from the base color of the tire (e.g. base color of the tire composition when formed), to set off the color and provide contrast therebetween.

As shown in FIG. 4, a cross-sectional view of the tire reveals a substantially uniformly colored tire chemical composition throughout the thickness of the tire both at the tread 12 and sidewalls 14 and 16. This is achieved by selecting a chemical composition having a particular natural color and/or coloring a base tire composition with a coloring agent or additive, which is uniformly dispersed or distributed throughout the tire composition prior to formation into a tire. This embodiment of the tire according to the present invention will continue to be substantially a uniformed color even as the tread portion 12 wears, since the coloring agent or additive is substantially uniform distributed throughout the thickness of the tread portion 12. The base chemical composition (e.g. natural rubber and/or synthetic rubber or other suitable polymer) and/or coloring agent can be selected so that the color remains fairly stable during the process of making (e.g. under heat and pressure). Alternatively, the base chemical composition and/or coloring agent can be selected so that the coloring develops during the process of making to reach a final color. As an alternative the whitewall portion 24 (or colored wall portion) extends over outer side tread portion 12b.

Optionally, the sidewall portion 14 can be provided with a whitewall portion 24 (or other suitable or desirable color), white or colored stripe 28 or stripes, and/or white or colored raised letters 29.

In another embodiment of the tire according to the present invention as shown in FIG. 5, the outer viewable surface of the tire is provided with a colored layer 30. Specifically, the tread portion 12′ and sidewall portions 14′ and 16′ are provided with an outer colored layer 30. However, in this particular embodiment, the colored layer 30 does not extend into the treads 13a′, 13b′ and 13c′. The tire composition 32 can be colored substantially identical to the colored layer 30 or can be of a different contrasting color to provide various visual effects. Alternatively, as shown in the embodiment in FIG. 6, the outer colored layer 30′ can extend into the treads 12a″, 12b″ and 12c″ to provide a substantial uniform colored exterior surface of the tire. As a further alternative, as shown in the embodiment of FIG. 7, the outer color layer 30″ includes a thicker outer tread layer 30a″ and thinner outer sidewall layer 30b″ to ensure that the tread remains substantially the same color as the sidewalls throughout the wear life of the tire.

The motor vehicle tire 10 shown in FIGS. 1-4 is substantially uniform in color. Specifically, the tire 10 is substantially uniformly colored (i.e. all colors, and not black and not white) on all surfaces and throughout the thickness of the tire. This particular embodiment of the tire 10 according to the present invention is made of a colored composition or material suitable for application as a motor vehicle tire. More specifically, a coloring agent or additive such as a dye, leuco-dye, pigment, metal oxide, metal powder, elemental metal, non-metal powder, solid, dispersion, colored polymer, and/or any other suitable coloring agent or additive can be utilized to color the tire composition uniformly prior to forming the material into a tire, developing the color during formation and/or even developing the color (i.e. during aging or subsequent treatment step) after formation of the tire.

Alternatively or in addition, some or all other surface portions of the tire (e.g. exterior surface) and/or non-viewable (e.g. interior surface) can be colored prior to, during and/or after formation of the tire depending on the particular processes and specification of the particular tire. For example, the outer surface of the tire can be provided with one or more layers of colored material and/or the outer surface after being formed can be treated so as to become colored.

Preferably, the tire chemical composition of the material itself is uniformly colored throughout prior to formation of the tire resulting in a tire having coloring throughout the thickness of the tire. Thus, when the tread of the tire wears, the newly exposed surface of the tread due to wear would be substantially the same color as previously. Further, the tire chemical composition and coloring agent or additive are preferably selected so that the color of the tire remains substantially stable throughout its life and resistant to color change (i.e. colorfast) due to heat, temperature, wear, stress, strain, elasticity and other physical and/or chemical factors applied to the tire. However, in some embodiments the chemical composition is designed to change color at some point during the life cycle of the tire (e.g. changes color due to wear).

The tire chemical composition is preferably of a type in which the coloring additive or agent is highly bonded (e.g. covalently) within the resulting material. Specifically, the color additive or agent is chemically reacted with precursors of the polymer and/or the polymer itself in the finished material, preferably resulting in cross-linking, and more preferably with a high percent or degree of covalent cross-linking. This will tend to make the color colorfast, fade proof, wear resistant, prevent leaching and/or smearing of colors. However, ionic type bonding between the coloring additive or agent in some embodiments may be acceptable.

The coloring agent and/or additives can be mixed and/or chemically reacted with prepolymers, carbon black, silica fillers and/or other components or starting materials of the tire chemical composition. It is desirable to mask or coat the carbon black by partial or fully micro-encapsulating the carbon black particles or chemically reacting same with coloring additive or agent to reduce and/or minimize the black coloring effect of carbon black while providing strength and durability in the resulting material. Alternatively, carbon black is totally eliminated in some formulations.

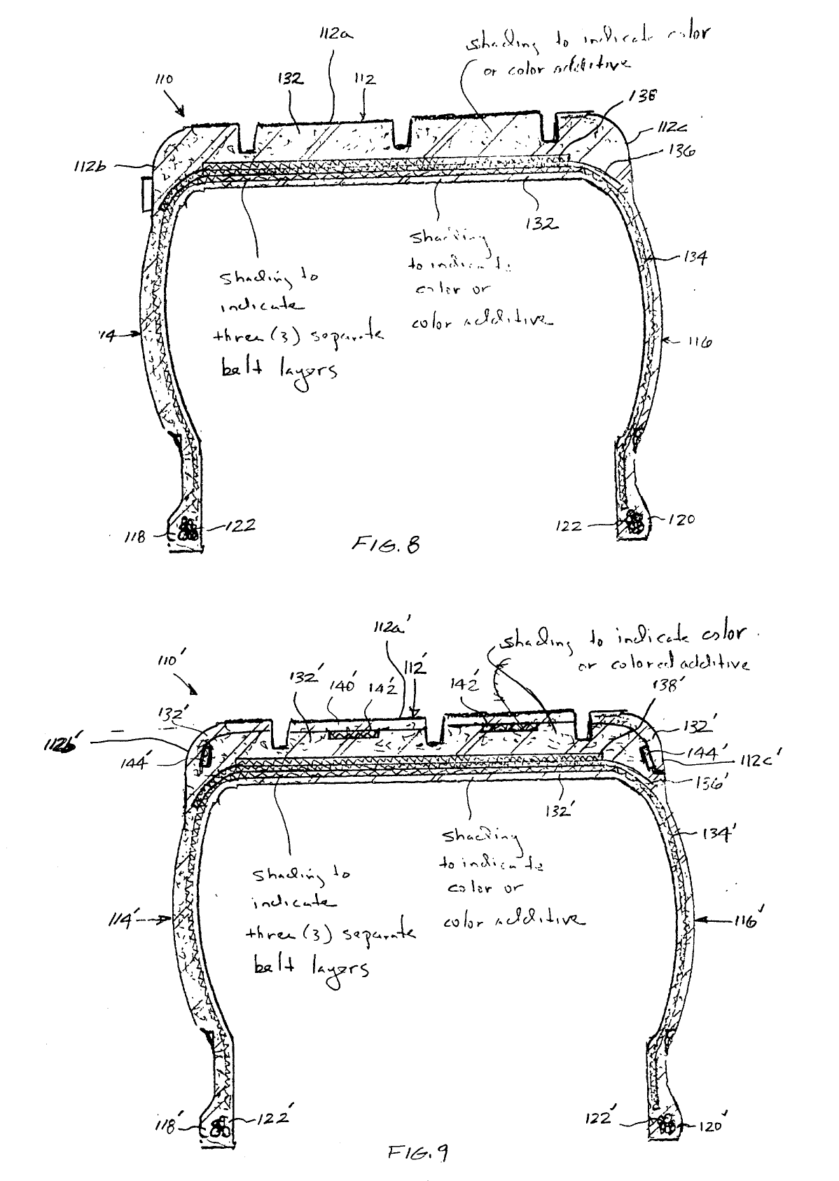

The tire according to the present invention preferably includes various components for reinforcing, stiffening, or otherwise strengthening the base tire composition itself. Specifically, as shown in FIG. 8, the motor vehicle tire 110 is provided with a plurality of separate belts 134, 136 and 138 for reinforcing the tire 110. Specifically, the belt 134 reinforces the tread portion 112 and the sidewall portions 114 and 116. The belts 136 and 138 further strengthens the tread portion 112. The belt portions 134, 136 and 138 can be natural colored (e.g. natural color of aramide, nylon or other strengthening fiber) and/or can be colored. For example, the belt portions 134, 136 and 138 may be colored to be substantially the same as the color of the tire base composition 132. Alternatively, potentially the tire base composition 132 can be translucent (e.g. see through, clear, colorless or colored) and the belt portions 134, 136 and 138 can be colored (e.g. all the same color or different colors to provide various visual effects). Further, the belt portions 134, 136 and 138 can be formed or treated to be luminescent, again to provide various visual effects when light is applied to the tire.

In the embodiment shown in FIG. 9, a clear (e.g. colorless, colored) or translucent layer 140 defines the outer surface of the tread portion and wraps around to portions of the sidewall portions 114 and 116. Strip lights 142 are provided underneath the clear layer 140 and the tread portion 112, and strip lights 144 are provided underneath the clear layer 140 on the sidewall portions 114 and 116. The strip lights can be white and/or colored (i.e. single color or a plurality of different colors) and can provide various visual effects. For example, the strip lights can be operated in a sequence or operated like a strobe (e.g. blinking in various time sequences such as repeating in a sequence or repeating randomly of blinking to another outside signal such as music). The strip lights 142 and 144 can be powered by a battery embedded within the tire 110, provided on the inside of the tire 110 (e.g. adhered to interior surface of tire), and/or located on the wheel of the tire. Alternatively, other power sources or power generating devices can be utilized in combination with these strip lights 142 and 144 for powering purposes. In addition, the strip lights 142 and 144 maybe connected to a control circuit for controlling the operation of the strip lights 142 and 144. For example, the control device can sequence the strip lights 142 and 144 in various sequence, changing the timing of the sequence, changing the periods of the sequence, operating the lights in a fixed pulse, random pulse or patterned sequence (e.g. music), and even allowing the remote operation of the lights for example from the hand held device (e.g. on key chain) or from the control console of the motor vehicle.

The motor vehicle tire according to the present invention is preferably a colored motor vehicle tire. Specifically, at least a portion of the exterior surface of the tire is colored (i.e. more or less, the exterior surface of tire exposed when mounted on a wheel). The term “colored” means all colors, but not including black and white. The motorized vehicle tire according to the present invention is configured to display a non-black and non-white colored surface preferably on at least twenty-five percent (25%) of the outer surface of the tire, even more preferably on at least thirty percent (30%) of the outer surface of the tire, more preferably on at least thirty-five percent (35%) on the outer surface of the motor vehicle, even more preferably on at least fifty percent (50%) of the outer surface of the tire, and even most preferably on at least ninety percent (90%) of the outer surface of the tire, and most preferably on one-hundred percent (100%) of the outer surface of the tire. Thus, the colored tire according to the present invention has a significant portion of the outer surface of the tire colored unlike black conventional tires. The colored outer surface can be a single colored surface or a multiple colored surface. A particularly desirable embodiment according to the present invention would be a uniformly colored tire optionally having raised lettering and/or stripes that are of the same color or a contrasting color depending on the manufacturer's, distributors and/or end user's preference. The tires according to the present invention can be custom colored to coordinate or match with the wheels, exterior body paint, exterior trim, interior color, interior trim and/or any other component of the motor vehicle.

The colored motor vehicle tire according to the present invention can include a visual pattern achieved by different colors and/or textures of the outer surface. Further, the motor vehicle tire according to the present invention can be provided with a colored design and/or artwork. For example, a photographic or digital image can be developed on the outer surface and/or provided in the outer surface of the tire according to the present invention. The artwork can be in the form of classic art, contemporary art, impressionist art, other types of art form, advertisements, signs, data, information, indicia, numbers, repeating patterns, non-repeating patterns, abstract design, and virtually any type of artwork desirable by the manufacturer, distributor and/or end user of the tire.

### EXAMPLE 1

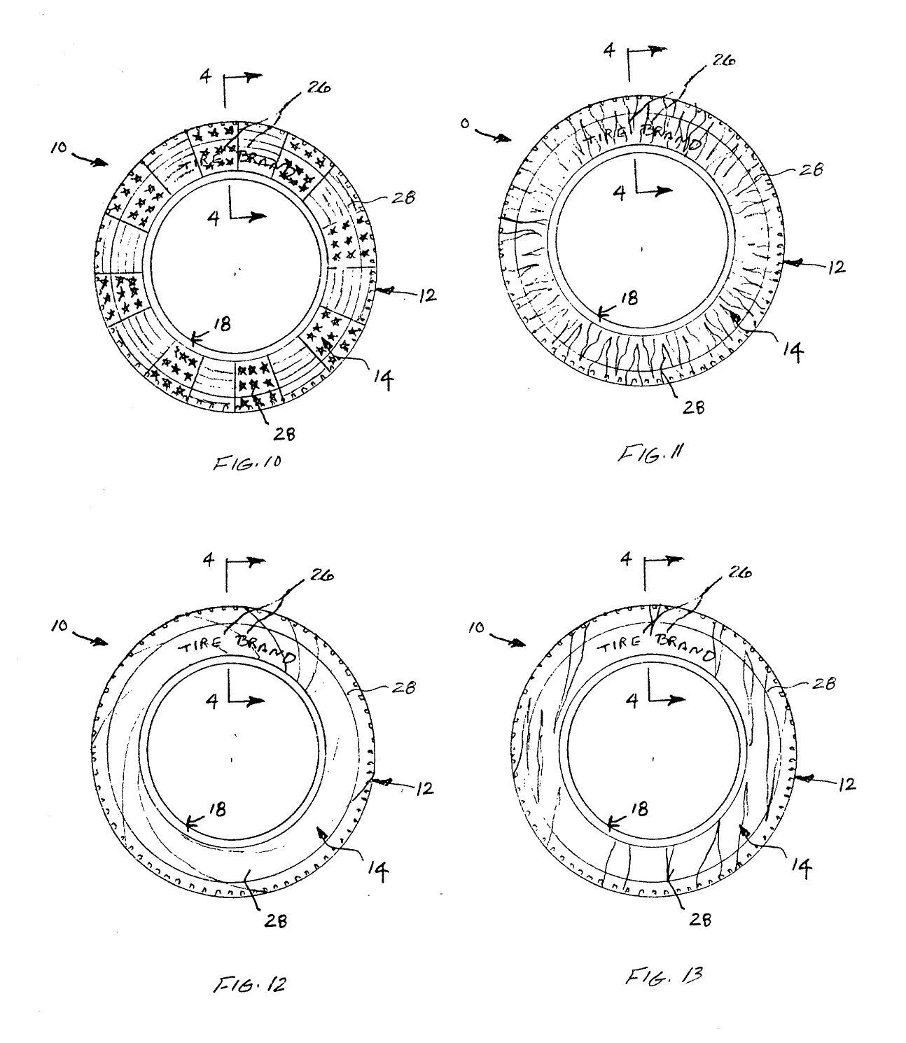

“STARS and STRIPES”—the stars and stripes pattern shown in the embodiment of FIG. 10 can be molded to provide a textured surface that extends outwardly and/or inwardly from the outer surface of the tire to provide the background pattern. The tire can have a uniform colored exterior surface. Alternatively, the stars and stripes can be colored according to the colors of the U.S. Flag in combination with the surface texturing of the outer surface of the tire.

### EXAMPLE 2

“STARS and STRIPES”—the tire according to the present invention as shown in FIG. 10 is provided with a substantially smooth outer surface and colored in the pattern and colors of the U.S. Flag.

### EXAMPLE 3

“FLAME”—the tire according to the present invention shown in FIG. 11 is provided with an outer surface having a substantially uniform color in combination with raised texturing in the outline of multiple flames extending both inwardly and outwardly as shown.

### EXAMPLE 4

“FLAMES”—the tire according to the present invention as shown in FIG. 11 is provided with a flame pattern having different color flames and/or outlines of flames as shown.

### EXAMPLE 5

“VORTEX”—the tire according to the present invention as shown in FIG. 12 is a substantially uniform colored tire having raised curved vortex-like lines as shown in FIG. 12.

### EXAMPLE 6

“VORTEX”—the tire according to the present invention as shown in FIG. 12 is provided with a plurality of adjacent vortex-like waves having different colors or different shades of a particular color around the perimeter of the tire as shown in FIG. 12.

### EXAMPLE 7

“CAMOUFLAGE”—the tire according to the present invention as shown in FIG. 13 is provided with a substantially uniformly colored exterior surface with raised pattern or raised outline of pattern as shown.

### EXAMPLE 8

“CAMOUFLAGE”—the tire according to the present invention as shown in FIG. 13 is provided with a substantially smooth exterior surface and colored in the camouflage pattern as indicated. Specifically, the tire can have colors similar to a forest, desert or other landscape in which the motor vehicle will operate.

The process described maybe used on any state of the art chemical compositions that maybe used for tire material including both natural rubber and synthetic rubber. The tires of the present invention may be manufactured by any state of the art commercial process that will produce tires that are suitable for modern day use on modern day motor vehicles and will result in tires that are of non-black and non-white color. Such process may include heat treatment of the tire material as well as a curing process to produce synthetic rubber.

To the manufacturing process of the tire is added a coloring agent or additive such as dye or pigment or other suitable coloring agent so as to produce a rubber or synthetic rubber composition suitable for tires that has a non-black and non-white color evenly dispersed throughout the tire composition. By “fully colored” it is meant that the tire composition itself is of a non-black and non-white color and this color remains throughout the density of the tire so that the color is an inherent ingredient of the chemical composition.

The resulting tire will be of a non-black and non-white color that is distinctive from the modern day, state of the art black colored tires. Such color will preferably stand out in appearance. It is thought that colors such as reds or blues will provide a good aesthetic effect and may provide a striking appearance. Woodland hues such as greens, brown and yellows maybe used for a less obtrusive and more natural looking appearance to the tire and the vehicle.

Lighter shades such as grays, off whites, beige, and pastels may also be used to provide a cleaner look and may be more easy to see in the dark and to spot signs of damage to the tire. The aforementioned list of colors is not meant to be exhaustive but merely illustrative of the type of colors and the resulting effects that may be produced by the use of such colors.

It is believed that many types of commercial rubber compositions maybe suitable for practicing the invention. Such types of rubbers may include commercial polymer and pre-polymers that form vulcanizable rubber products as well as natural rubbers. Natural rubber products may also be used in the tire manufacturing process. To these rubber pre polymers and natural rubbers maybe added a coloring agent or additive such as pigment or dye such that the coloring agent or additive will produce a non-black and non-white color when the finished product is created.

For instance, certain types of titanium dioxides will produce a light colored and these types of coloring agents may be added to the polymerizable compositions when the polymer of the tire composition is formed to form a base color that can then be custom colored. Metallic based oxides as well as cyano dyes, or di-aryl based dyes or other types of dyes may be used. Other types of colors may be used without violating the spirit of the invention. Other state of the art ingredients that may be used in the tire manufacturing process include stabilizers, fillers, cross linking agents, catalysts, sealants, preservatives and other ingredients that are recognized in the art as suitable for use in manufacturing tires.

The types of metallic particles that may be used in the coloring process may be of any size or shape that is found to be suitable for the purposes of vehicle usage and after due allowance is made for trial and error in the design and development process. Such metallic particles may include oxides of metals and/or metal alloys of elemental metals. Some types of oxides that may be of use in the invention include titanium dioxide and zinc oxides. Other dyes and pigments may be used without varying from the spirit of the invention.

Motor vehicle tires with a lighter pigmented body may absorb a reduced amount of ultraviolet light rays and light from other parts of the spectrum and this, in turn, will lower the amount of energy that is absorbed and thus, the rate of rubber degradation in the tire is slowed by increasing the light reflectance of the tire. Such degradation may occur due to long exposure to the elements and is more likely to occur when the tire is not actually in use on the wheel as rotation of the tire gives effect to the blooming process for tire protection.

Additional additives may be used in lieu of, or in combination with, state of the art carbon black compositions to absorb and/or dissipate the ultraviolet energy. Such dissipation would be in addition to that provided by the use of the lighter inherent colors of the novel tires. A silica based process may also be used in the place of the carbon black process and other methods referred to above.

Ultraviolet ray absorption may also be combated with reflective materials and additives in the chemical composition proper or on the surface of the tire, thus reducing the level of ultraviolet ray penetration and resulting damage. Standard methods used in the commercial field may be still be used to enhance the dissipation of absorbed energy in the tire. The use of the lighter colored motor vehicle tires should not preclude these processes. Other methods of transferring heat from the motor vehicle tire may be used without violating the spirit of the invention.

One such method would be a sacrificial protectant process, such as blooming, that may be utilized to protect the surface of the tire. Such blooming results in ozone protection of the tire. Other methods that achieve the same effect on the tire surface may also be practiced with the invention.

It is preferred that the pigment or coloring agent used in the manufacturing process should be dispersed in a continuous and even manner throughout the tire material or chemical composition of the motor vehicle tire. That is the lighter colored agent is not merely a coating or an applique but rather it is fully dispersed throughout the density of the tire and as such the tire will not change in color when a cut or other damage occurs to the surface of the tire. In other words, it is preferred that the tire is not surface coated by the pigment or dye, such non-black and non-white color remains throughout the depth of the tire. It will be red, or whatever color is used, through the whole tire. However, surface coatings or layers that are colored may be utilized, with or without coloring agent throughout the tire material, to achieve certain visual effects, and provide some embodiments of the tires according to the present invention.

Such coloring agents may be enhanced by the use of reflective materials as an option, that will reflect some portions of ambient light and so brighten the appearance of the tires at night. Such reflective materials maybe the same or in addition to the coloring agents used to produce the non-black color. Such reflective materials may be specially formulated for use in the nighttime when ambient light is at a minimum or for daylight hours when light is at a maximum. Such materials may include metallic and/or plastic agents that reflect light.

Other optional embodiments include optional pigments that may enhance the visual effect of tires at night. Such options may include the use of photo chromic or photo luminescent type of dyes and/or pigments. Such photoluminescent type pigments may allow for a glow in the dark effect of the motor vehicle tires at night. Such materials are widely used in other type of applications today and may be adapted for use in motor vehicle tires. Such materials may absorb energy from light during the daylight hours and then return the energy in the form of luminescence at night. The visual effect may be quite striking when used on a vehicle and may serve as an additional warning to motorists and pedestrians that a vehicle is in the area.

The use of photochromic materials allows for color changes that take place due to change in temperature. Again such materials in a vehicle tire could enhance the visual effect of the tires on a day when the ambient temperature rises or falls. Such visual effect at night could increase the safety of automotive driving at night. Such photochromic materials can also provide visually appealing patterns that are characteristically complicated in appearance.

What is claimed is:

1. A motorized vehicle tire device, comprising:
a motorized vehicle tire configured to display a non-black and non-white colored surface preferably on at least twenty-five percent (25%) of an outer surface of said tire.

2. A motorized vehicle tire device, comprising:
a motorized vehicle tire configured to display a non-black and non-white colored surface preferably on at least thirty percent (30%) of an outer surface of said tire.

3. A motorized vehicle tire device, comprising:
a motorized vehicle tire configured to display a non-black and non-white colored surface preferably on at least thirty-five percent (35%) of an outer surface of said tire.

4. A device according to claim 1, wherein said tire is configured to display a non-black and non-white colored surface more preferably on at least fifty percent (50%) of an outer surface of said tire.

5. A device according to claim 2, wherein said tire is configured to display a non-black and non-white colored surface most preferably on at least ninety percent (90%) of an outer surface of said tire.

6. A device according to claim 1, wherein said non-black and non-white colored surface is a single colored surface.

7. A device according to claim 1, wherein said non-black and non-white colored surface is a multiple colored surface.

8. A device according to claim 1, wherein said outer surface of said tire includes at least one black colored portion.

9. A device according to claim 7, wherein said outer surface includes at least one white colored portion.

10. A device according to claim 1, wherein said tire is provided with a visual pattern.

11. A device according to claim 1, wherein said visual pattern is a colored pattern.

12. A device according to claim 1, wherein said tire is provided with lettering.

13. A device according to claim 12, wherein said tire is provided with raised lettering.

14. A device according to claim 1, wherein said tire is provided with at least one symbol.

15. A device according to claim 1, wherein said tire is configured to display advertisement.

16. A device according to claim 1, wherein said tire is provided with artwork.

17. A device according to claim 1, wherein said tire is provided with at least one raised pattern.

18. A device according to claim 1, wherein said tire is provided with at least one pin stripe.

19. A device according to claim 17, wherein said pin strip is a raised pin stripe.

20. A device according to claim 1, wherein said non-black and non-white colored surface is configured to remain substantially the same color throughout a life time of said tire.

21. A device according to claim 1, wherein said non-black and non-white colored surface is configured to change color with time.

22. A device according to claim 1, wherein said non-black and non-white colored surface is configured to change color with wear.

23. A device according to claim 1, wherein said non-black and non-white colored surface is configured to change color when activated by at least one selected from the group consisting of electromagnetic radiation, chemical, pressure and temperature.

24. A device according to claim 22, wherein said change of color is reversible.

25. A device according to claim 22, wherein said change of color is irreversible.

26. A device according to claim 1, including a device for lighting said tire.

27. A device according to claim 1, wherein an outer surface of at least one sidewall is a same color as an outer surface of said thread.

28. A device according to claim 1, wherein an outer surface of at least one sidewall is a different color from an outer surface of said thread.

29. A device according to claim 1, wherein adjacent threads are different colored surfaces.

30. A device according to claim 1, including a wheel, said tire being mounted on said wheel.

31. A device according to claim 29, wherein said tire is color coordinated with said wheel.

32. A device according to claim 1, wherein said tire is colored coordinated with the vehicle.

33. A device according to claim 1, wherein said tire is colored coordinated with at least one wheel and the vehicle.

34. A device according to claim 1, wherein said tire is colored coordinated with wheels of the vehicle, the exterior paint and trim of the vehicle, and an interior color and trim of the vehicle.

35. A device according to claim 1, wherein a chemical composition used to make said tire provides a substantially uniform colored surface when formed.

36. A device according to claim 34, wherein said chemical composition remains substantially uniform in color throughout its depth when formed.

37. A device according to claim 1, wherein a chemical composition used to make said tire provides a non-uniform colored surface when formed.

38. A device according to claim 1, wherein said chemical composition used to make said tire provides a patterned colored surface along at least one axis when formed.

39. A device according to claim 1, wherein said tires are made of a chemical composition that includes a coloring agent or additive.

40. A device according to claim 38, wherein said tires of made of a chemical composition that includes a coloring agent that is dispersed throughout the density of said composition and such coloring agent is capable of forming a non-black and non-white color that is fully developed throughout the depth of the tire composition.

41. A device according to claim 40, wherein said coloring agent is chosen from the group consisting of metallic particles, metallic alloys, oxides of metals, dyes, pigments, photochromatic materials, reflective materials, and silica based compositions.

42. A device according to claim 1, wherein said tire is configured to change color when said tire changes temperature.

43. A device according to claim 1, wherein said tire is configured to change color when said tire changes pressure.

44. A device according to claim 41, wherein said tire is configured to change color when said tire changes pressure.

45. A device according to claim 1, wherein said tire is configured so that said tire changes color when the vehicle changes speed.
